(19) United States
(12) Patent Application Publication
(10) Pub. No.: US 2012/0234107 A1
(43) Pub. Date: Sep. 20, 2012

(54) NON-CONTACT TORQUE MEASUREMENT APPARATUS AND METHD

(75) Inventors: Sairam KS Pindiprolu, Pune (IN); Vimal V. Shah, Pune (IN); Li Gao, Katy, TX (US)

(73) Assignee: HALLIBURTON ENERGY SERVICES, INC., Houston, TX (US)

(21) Appl. No.: 13/478,747

(22) Filed: May 23, 2012

Related U.S. Application Data
(63) Continuation-in-part of application No. 12/869,447, filed on Aug. 26, 2010.

(51) Int. Cl. G01L 3/10

(52) U.S. Cl. 73/862.331

(57) ABSTRACT

Disclosed is an apparatus and method for accurately measuring torque in a rotating shaft. The apparatus comprises axially spaced magnet-detector pairs, mounted to rotate with the shaft and means for sensing relative rotation between the magnets.

### CROSS REFERENCE TO RELATED APPLICATIONS

This application is a continuation-in-part of U.S. application Ser. No. 12,869,447, filed on Aug. 26, 2010.

### BACKGROUND

1. Technical Field

This invention relates, generally, to apparatus and methods used in measuring torque in a shaft. In particular, this invention relates to non-contact torsion measurement on a rotating shaft assembly, comprising two rigid shafts segments connected by a flexible torsion member.

This invention relates to torque measurement in the following conditions while not compromising on performance and accuracy:

1) Harsh environments, High Pressure, High Temperature;

2) Presence of Corrosive, Particle Laden and Non-Clear (dirty) fluids;

3) High Rotating Speeds;

4) Wide Span of Torque Ranges over several orders of magnitude;

5) End of Shaft not accessible;

6) Large Offset Distances between Shaft and Sensing elements; and

7) Vibration and Noise.

In one embodiment, this invention relates to testing apparatus and methods for monitoring mixing torque on liquids, gels, slurries or pastes enclosed under specific pressure and temperature conditions and, in particular, apparatus and methods for testing fluid mixtures and slurries for use in subterranean wellbores under simulated wellbore conditions.

2. Background Art

When drilling, completing, and treating subterranean hydrocarbon wells, it is common to inject materials in fluid form with complex structures, such as suspensions, dispersions, emulsions and slurries. These injected materials are present in the wellbore with materials such as water, hydrocarbons, and other materials originating in the subterranean formations. The materials present in the wellbore will be referred to herein as “wellbore fluids” or “wellbore liquids.” The flow of these fluids and mixtures cannot be characterized by a single viscosity value, instead the apparent viscosity and shear stresses changes due to other factors such as temperature and pressure and the presence of other materials. Two fluids are incompatible if undesirable physical or chemical interactions occur when the fluids are mixed. Incompatibility is characterized by undesirable changes in apparent viscosity and shear stresses. When apparent viscosity of the mixed fluids is greater than apparent viscosity of each individual fluid, they are said to be incompatible at the tested shear rate. An example of when compatibility of fluids is important may include the scenario below.

It is common to determine optimum wellbore liquids and incompatibility of those liquids in a laboratory by running a series of tests of different liquid mixtures under wellbore conditions. Testing various ratios of mixtures of wellbore liquids is done to replicate the changes in the wellbore concentrations of the fluids. Testing a series of samples of actual wellbore mixtures during well treatment is also common. Viscosity, visco-elasticity, shear stress, and consistency are rheological characteristics that need to be measured for a given fluid or mixture.

Known prior art devices used to test fluids for these characteristics include viscometers, rheometers and consistometer. Examples include those illustrated and described in U.S. Pat. Nos. 3,435,666, 4,668,911, 5,535,619 and 6,951,127, which are incorporated herein by reference for all purposes. Testing comprises filling a test chamber with a first mixture, bringing the chamber to pressure and temperature test conditions, and then conducting tests of the fluids characteristics. In some prior art testing devices, apparent viscosity is tested by measuring the torque required to rotate a paddle in a closed or sealed housing containing the test fluid. In these prior art devices, the tests are conducted at elevated temperatures and pressures. For instance rheology measurement applications in harsh conditions, requires an accurate but non-invasive measurement technique. Typically, these devices use a paddle rotated in a test fluid. The torque required to rotate the paddle in the fluid corresponds to the apparent viscosity of the fluid.

Other applications include monitoring torque during mixing, and measuring torque on a rotating engine shaft and the like. Non-contact measurements have been previously carried out using optical encoders and non-offset magnetic systems. Optical encoders require clear fluids, and non-offset systems need the end of the shaft to be accessible to mount the sensor. Prior art systems have been deployed to measure angular displacement only, such as: Gear Tooth Detection Devices; Non-Offset Systems; and Systems with High Proximity between magnet and sensor.

### SUMMARY OF THE INVENTIONS

According to the apparatus and methods of one embodiment of the present invention, torque in a shaft can be measured accurately under difficult conditions using a magnetic-detector configuration. Permanent magnets placed along the shaft induce current or a voltage output in the detectors and, from the phase shift in the detector outputs, the torque can be calculated, knowing the properties of the shaft. The detectors can be used with Hall Effect sensors or other magnetic field sensors to detect magnet polarity.

### BRIEF DESCRIPTION OF THE FIGURES

The advantages and features of the present invention can be understood and appreciated by referring to the drawings of examples attached hereto, in which:

FIG. 1 is a schematic diagram of the testing apparatus of the present inventions;

FIGS. 2-4, and 6 illustrate a magnet configuration and mounting for use in the present inventions; and

FIG. 5 illustrates the non-contact torque measuring device of the present invention on a motor shaft.

### DETAILED DESCRIPTION OF THE INVENTIONS

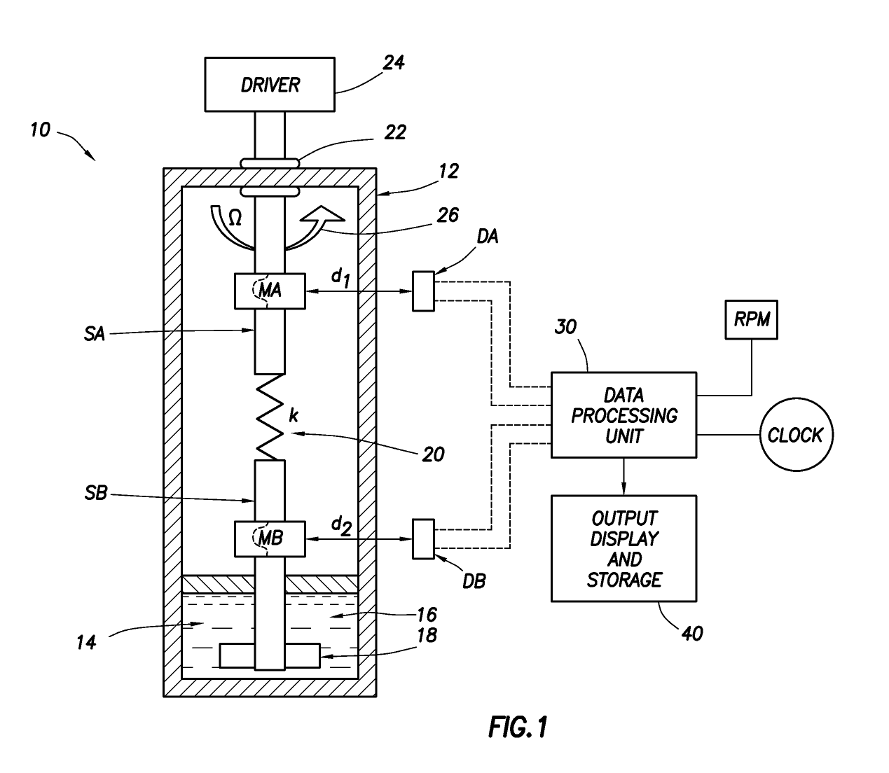

Referring now to the drawings, wherein like or corresponding parts are designated by like or corresponding reference numbers throughout the several views, there is schematically illustrated in FIG. 1, a fluid testing apparatus 10 embodying the method and apparatus of the present inventions. The apparatus 10 comprises a housing 12, enclosing a test chamber 14 containing the fluid 16 to be tested. The space in the housing 12 above the test chamber can be filled with an inert fluid. In the preferred embodiment, the housing and the test chamber are sealed enclosures that can be raised in pressure to perform tests on the fluid in the chamber 14. A shaft formed by two shaft segments SA and SB extends into housing 12. According to the present inventions, a paddle 18 mounted on shaft SB is rotated in the test chamber 14 while in contact with the test fluid 16 to measure the apparent viscosity of the test fluid.

In one embodiment, a resilient member embodied as a torsion spring 22 with the spring constant k, couples or connects shaft segment SA to shaft segment SB. As used herein, the term “resilient member” refers to a member that has the ability to absorb energy when it is deformed elastically and release that energy upon unloading. Resilient members include springs and elastic items that are capable of returning to an original shape or position after having been deformed. The spring should be selected with a constant k that is linear (or within Hookean range) for the operating range of the apparatus. Alternatively, the spring embodiment could be a Flexural Pivot Bearing, such as the Cantilevered Single Ended Pivot Bearings or the Double Ended Pivot Bearings supplied in various sizes by Riverhawk Flexural Pivots Company of Hartford, N.Y.

The shaft segment SA is, in turn, mechanically coupled at 22 to a driver 24. Typically, the driver 24 is an electrical motor which is coupled to the shaft segment SA through the wall of the housing 12, using a conventional a magnetic coupling 22. The magnet coupling has a driver magnet outside the housing coupled by magnetic forces to drive a follower magnet located inside the housing. Suitable bearings (not shown) can be used to maintain the shaft in position in the housing. Alternative to using an externally mounted driver 24 with a through wall coupling 22, the driver 24 could be mounted in whole or part inside the housing.

Magnets MA and MB are mounted to rotate with shaft segments SA and SB with their magnetic field substantially perpendicular to the shaft, respectively. Detector DA is located outside the housing 12 in the proximity of (distance d1) magnet MA. Detector DB is located outside the housing 12 in the proximity of (distance d2) the magnet MB. Detectors DA and DB are connected to data processing unit 30 which, in the present embodiment, determines the phase shift between detectors DA and DB when torque is applied to the shaft segments. The Processing unit also includes a counter and clock to provide output data regarding the shaft speed and time. A display-data storage unit 40 is connected to the output of the unit 30 for recording data from detectors DA and DB and processed data from unit 30. Data acquisition can be carried out using the PX14330 card supplied by National Instruments. Waveform analysis can be carried out to extract information on phase shift, using standard Digital Signal Processing (DPS) techniques. In addition, phase detection can be carried out on the waveforms generated by the AMR sensors, using Model 7270 DPS Lock in amplifier and the SR810 or SR830 from Signalrecovery and Stanford Research Systems, respectively.

In operation, test fluid 16 is added to test chamber 14, and the pressure and temperature test conditions are applied. Motor driver 24 is activated to rotate shaft A at a speed Omega as illustrated by arrow 26. Torsion spring 20 couples shaft segments SA and SB and transfers the rotation of shaft segment SA to shaft segment SB. As shaft segment SB rotates, the paddle 18 is rotated in the test fluid 16. Contact between the paddle 18 and the test fluid 16 retards the rotation shaft B which, in turn, causes twisting or relative rotation (angular deflection) between shaft segments SA and shaft SB due to the deflection in torsion spring 20. The term “torque” (measured in force multiplied by distance) is used herein to indicate applying a twisting force to an object to tend to cause rotation. The term “torsion” is used herein to describe the shearing stress in a shaft or other object when torque is applied. Torsion, of course, varies from zero at the axis to a maximum at the outside surface of a shaft. By calibrating the device and measuring the relative rotation between shafts A and B, the apparent viscosity of the test fluid 16 can be determined.

The detectors used in the apparatus of the present invention are Wheatstone bridge-type elements. Magnetic field detectors can comprise a coil wound with insulated conducting material. These detectors comprise resistive elements whose resistance changes with the orientation of the magnetic field and preferably are Anisotropic Magneto Resistance (AMR) effect sensors supplied by Honeywell Inc. Sensors using this technology are classified as saturation mode or liner mode sensors. For example, position sensors (HMC1512 supplied by Honeywell Inc) are classified as saturation mode sensors. The output of these sensors is an electrical signal and, in some sensors, is in the form of a sinusoidal wave, having twice the frequency of the rotation of the shaft. These sensors can be used with Hall Effect Sensors that act as polarity detectors as to which pole of the magnet is rotating. The phase shift between the detector outputs is measured to determine applied torque.

The second kind of AMR detectors that can be used are supplied by Honeywell Inc. For example, HMC 1512, 102X, 104X and 105X sensors offered by Honeywell, Inc could be used to infer magnetic field by measuring the voltage response. These sensors are available in single-axis, 2-axis and 3-axis configurations to measure the magnetic fields in space. These sensors work on the same principle as saturated mode sensors but provide a full 360-degree detection and exhibit a linear relationship between the output voltage and the magnetic field. In addition, Giant Magneto Resistance sensors from NVE Corporation may be used in some applications.

Additionally, in lieu of Hall effect sensors or AMR, GMR sensors, one may also use detectors made of multiple turns of coil wound using insulated metal wires such as insulated copper wire which generates induced voltage in the presence of the rotating magnets MA and MB.

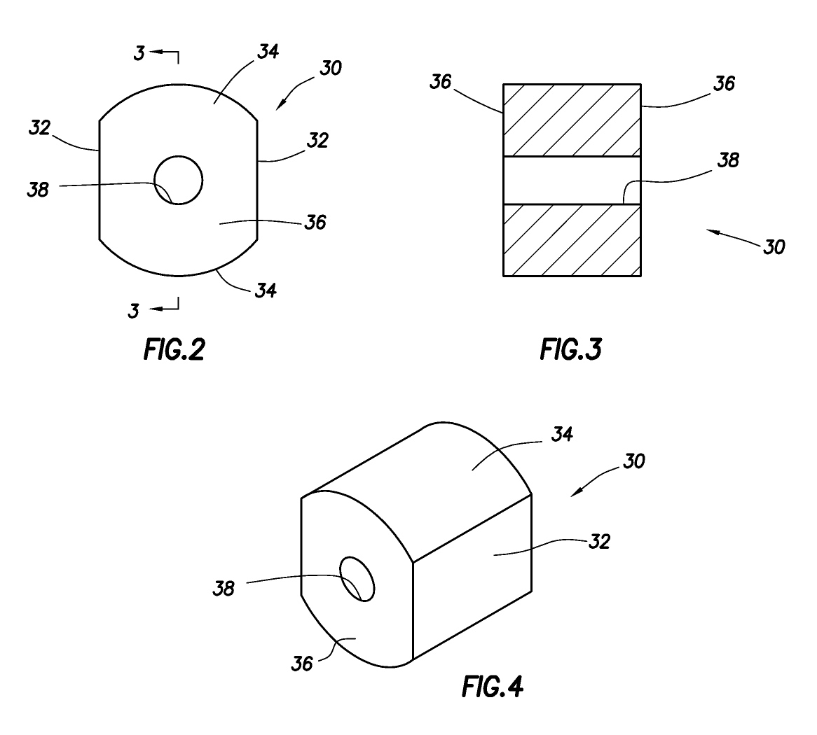

According to a particular feature of the present invention, the preferred generally rectangular shape of the magnets A and B is illustrated in FIGS. 2-4. This shape is particularly suited to measuring the relative angular position of shafts rotating at high speeds. In these figures, the magnet is identified, generally by reference numeral 30. The magnet body can best be described as having a generally rectangular cross section with two opposed, flat faces 32 formed by parallel straight lines and two opposed curved faces 34 formed by arcs. The arcs are preferably semicircular. The magnet is designed with bore 38 positioned to receive a shaft to be rotated about the geometric center of the generally rectangular cross section. As used herein, the term “generally rectangular” refers to a shape that has sides and is elongated in the direction between its magnetic poles. The end faces 36 of the magnet are planar. The magnetic field orientation M is diametrical. A central bore 38 extends through the magnet between the ends 36. In FIG. 6 the magnet 32 is illustrated clamped onto the shaft SA by a mounting bracket M. As illustrated in FIG. 6, the bore 38 is of a size to receive shafts A or B for mounting. The flat faces 32 are used to fix the magnets in an angular position on the shaft in bracket M. The bracket M is fixed to rotate with the shaft SA. Bracket M has a bifurcated portion forming a straight sided slot in which the magnet 32 is nested. The sides of the slot fit snugly against the faces 32 to prevent rotation of the magnet 32 with respect to the bracket and shaft. A set screw or the like is used to releasable hold the magnet in axial position in the bracket. By mounting the magnets in the manner the magnets can be easily changed out as required. In an alternative embodiment, the flat faces are replaced with planar faces, giving the magnet a rectangular, cross-sectional shape.

Preferably, the magnet is made from materials that can operate at high temperatures, for example, Sm5Co17 or Alnico. The size of the magnets are selected such that the minimal measurable magnetic field is at least in the order of the measuring range of the sensor.

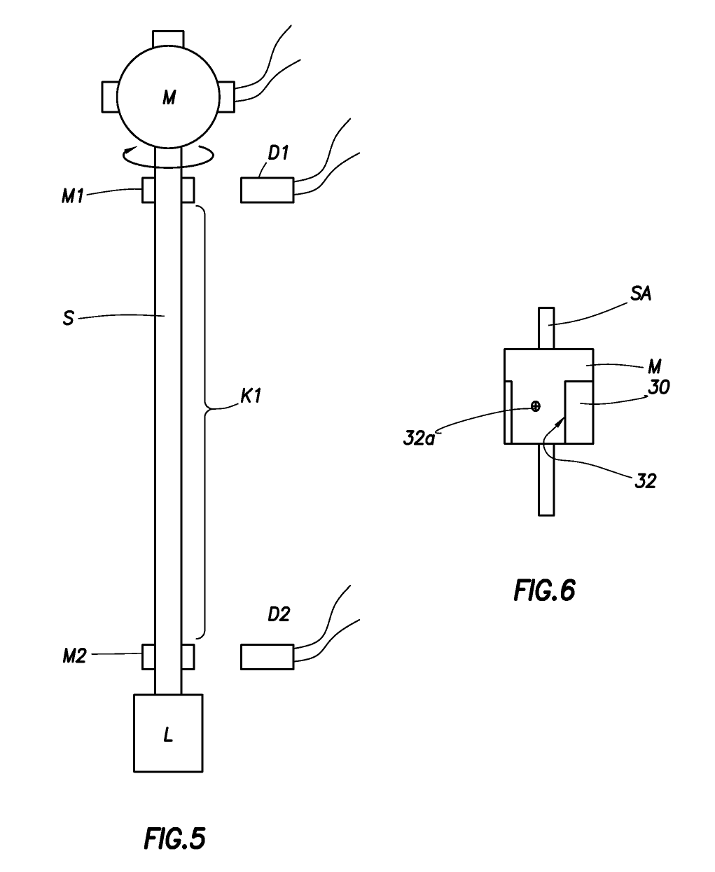

An alternative application of the present invention is illustrated in FIG. 5. Motor M drives shaft S which is connected to a load L. As illustrated, the motor is located outside a sealed enclosure or housing H (depicted as dotted lines), however, the system is useful in applications where no housing is present, such as where access to the shaft is limited. In operation, shaft S is twisted by the force applied by the motor to the shaft. The torque required to drive the load at a given speed can be measured by installing axially spaced magnets M1 and M2 to rotate with shaft S. Detectors-magnet pairs D1-M1 and D2-M2 sense the position of the shaft at the detectors as shaft rotates. Torque in the shaft can be determined by measuring the twist in the shaft between the detectors. In this application, the two shaft segments are formed into a unitary shaft without the torsion spring used in the FIG. 1 embodiment. The actual twist or distortion in the rotating shaft is used to determine the torque in the shaft.

The housing itself can have an effect on the performance of the measurements. For the magnets MA and MB to “transmit” their fields to sensor A and sensor B, respectively, the housing which typically holds the pressure and temperature should be formed, at least in part, from non-magnetic materials. The term “non magnetic” is used to refer to materials that do not stick to magnets, such as materials like SS-316L, inconel 718, MP35N, etc. Non-magnetic materials will have a magnetic relative permeability value of about 1. Preferably, the housing will be formed from non-metallic materials so that the magnetic field will be transmitted through the housing wall. In some embodiments, it is preferable that a portion of the housing structure between the magnet and its sensor will be made out of a non-magnetic material.

According to the present inventions, the position of magnet MA on shaft segment SA acts as a reference point against which the position of magnet MB on shaft segment SB is measured. In applications where shaft segment SA and shaft segment SB are connected by a flexible member, such as a torsion spring, flexural pivot, or the like, the reference point may determined alternatively. In applications where the shaft segments are relatively rigid, the reference point may be determined at different locations in the system.

When driver 24 is a motor, magnet MA may be mounted on the motor shaft outside the housing, provided there is no material slippage between the motor and the shaft segment SA. If the driver is coupled to shaft segment SA by a belt, magnet MA may be mounted on the driven pulley shaft. In another embodiment, the field lines of the magnetic coupling 22 can be sensed as a reference. The waveform from the coupling is of the type: Asin(wt+a)+Bsin(2 wt+b). The primary frequency signal can still be processed on the fly by extracting the multitone information and digital signal processing to filter out the required reference signal [Asin(wt+a)]. Therefore, in one of the embodiments, more than one magnet may be disposed in the mounting location to provide measurements.

Quality of the data is very important to get meaningful torque measurements. Before applying a phase measurement algorithm like convolution, cross correlation or using a lock-in-amplifier, it has to be ensured that both the signals (reference magnet/Magdrive as well as bottom magnet) are perfectly sinusoidal with minimal distortion. Both signals are of the same frequency before applying the phase shift algorithms which can be done both in the time domain as well as frequency domain. Application of filters and noise reduction should be done, ensuring, however, meaningful data is not lost. The calculated phase difference will not “stabilize” if the quality of data is bad.

While the preceding description contains many specificities, however, it is to be understood that same are presented only to describe some of the presently preferred embodiments of the invention, and not by way of limitation. Changes can be made to various aspects of the invention, without departing from the scope thereof.

Therefore, the scope of the invention is not to be limited to the illustrative examples set forth above, but encompasses modifications which may become apparent to those of ordinary skill in the relevant art.

What is claimed is:

1. An apparatus of measuring torque transmitted between first and second rotating shafts assembly comprising; one clamp disposed on the first rotating shaft; a second clamp disposed the second rotating shaft, magnets removably mounted in the clamps, an elastic member connecting the shafts whereby the elastic member twists corresponding to the torque transmitted between the two shafts; and output means sensing the magnetic fields of the magnetic, the output means mounted remote from the shafts without the presence of any electrical circuitry or wiring on the shafts.

2. An apparatus for measuring the torque in a rotating shaft, the apparatus comprises:
a plurality of permanent magnets mounted in axially spaced relationship to rotate with the shaft; and
output means positioned in the magnetic field of each magnet and providing an electrical signal responsive to the changes in the magnetic fields of each magnet.

3. The apparatus of claim 2, additionally comprising a sealed enclosure, and wherein the magnets and shaft are located within the enclosure and the output means is positioned outside the enclosure.

4. The apparatus of claim 3, wherein the enclosure comprises housing made, at least in part, from non-magnetic material.

5. The apparatus of claim 1, wherein each output means has an electrical output corresponding to the changes in the magnetic field.

6. The apparatus of claim 5, wherein the electrical signal from the output means has a periodic pattern.

7. The apparatus of claim 5, additionally comprising means for determining the phase shift in the sinusoidal electrical output signals of the output means.

8. The apparatus of claim 2, wherein said output means are magnetic field detectors.

9. The apparatus of claim 2, wherein said output means are anisotropic magneto resistance effect, Giant magnetoresistance effect or Colossal Magnetoresistance-type sensors.

10. The apparatus of claim 8, wherein said magnetic field detector is a coil wound with insulated conducting material.

11. The apparatus of claim 2, wherein the portion of shaft between the magnets twists when torque is applied to the shaft.

12. The apparatus of claim 2, wherein the shaft comprises separate coaxial segments.

13. The apparatus of claim 12, additionally comprising a torsion spring, joining the segments.

14. The apparatus of claim 13, wherein the torsion spring comprises a flexural pivot bearing.

15. The apparatus of claim 2, additionally comprising means for processing the output from the detectors to determine the angular deflection of the shaft between the magnets.

16. The apparatus of claim 15, additionally comprising a data recording means coupled to the processing means for storing data regarding the angular deflections in the shaft.

17. The apparatus of claim 15, wherein the data processing means additionally comprises a clock.

18. The apparatus of claim 15, wherein the data processing means additionally comprises means for determining rotation speed of the shaft.

19. A method for measuring the torque in a rotating shaft assembly of the type comprising two rigid shafts segments connected together by a resilient member, the method comprising the steps of:
establishing the relative angular position of the two shaft segments when no torque is applied through the shaft assembly;
rotating the shaft assembly while applying torque through the shaft assembly;
determining the deflection in the resilient member by sensing the relative annular positions of a first shaft segment with respect to the second shaft segment; and
determining the torque in the rotating shaft assembly by using the relative angular deflection between the two shaft segments.

20. The method of claim 19, additionally comprising the steps of:
mounting permanent magnets to rotate with the shaft segments; and
sensing changes in the magnetic fields of said permanent magnets while the shaft is rotating to determine the angular deflection between the shaft segments; and
determining the torque in the shaft, using the angular deflection.

21. The method of claim 19, additionally comprising the step of connecting the shaft segments with a torsion spring, and wherein at least one magnet is mounted to rotate with each segment.

22. The method of claim 20, wherein the step of sensing changes in the magnetic fields comprises mounting magnetic field detectors adjacent the magnetic fields.

23. The method of claim 20, wherein the step of sensing changes in the magnetic fields comprises mounting an anisotropic magneto resistance effect-type sensor.

24. The method of claim 20, wherein the step of sensing changes in the magnetic fields comprises mounting a linear mode type sensor.

25. The method of claim 20, wherein the step of determining comprises the step of processing the output from the detectors to determine the angular deflection of the shaft between the magnets.

26. The method of claim 20, wherein the step of sensing changes in the magnetic field comprises generating an electric output signal varying in voltage, corresponding to the changes in magnetic field.

27. The method of claim 26, wherein the step of sensing comprises generating sinusoidal electrical output signals.

28. The method of claim 27, wherein determining comprises determining the phase shift between the sinusoidal electrical output signals.
